(19) United States
(12) Patent Application Publication
(10) Pub. No.: US 2006/0243808 A1
(43) Pub. Date: Nov. 2, 2006

(54) Utility pole identification system

(76) Inventor: Albert A. Burlando, Flanders, NJ (US)

Correspondence Address: THOMAS J. GERMINARIO, ESQ., 154 ROUTE 206, CHESTER, NJ, 07930, US

(21) Appl. No.: 11/115,145

(22) Filed: Apr. 27, 2005

(51) Int. Cl. G06K 19/00

(52) U.S. Cl. 235/487

(57) ABSTRACT

A utility pole identification system in which alphanumeric symbols and a replaceable bar code insert are incorporated into a tag which is affixed to a pole, with the symbols and bar code used to display information concerning the pole and/or utility equipment supported thereon. The information thus encoded in the tag can be read by utility inspection/maintenance personnel.

### BACKGROUND OF THE INVENTION

Utility poles are generally identified by a tag or marker attached to the pole. Such tags/markers typically contain a series of alphanumeric symbols that encode information concerning the pole itself and/or the utility apparatus supported thereon. The information thus encoded in the tag/marker is designed to be read by utility personnel involved with the inspection, maintenance and repair of the pole and its associated apparatus. Such encoded information may, for example, identify the pole and its ownership, indicate its installation date, disclose the voltage of supported power line or transformers, and/or specify its most recent inspection/maintenance date.

Since the information concerning a given utility pole installation may change over time, identification tags/markers are generally designed to allow the series of alphanumeric symbols encoding such information to be modified. The standard utility pole tag configuration consists of an oblong mounting frame with two parallel channels formed along its longitudinal edges. A flat oblong plate engraved or embossed with the appropriate series of alphanumeric symbols is dimensioned so that it slides into the channels of the mounting frame. Alternately, the alphanumeric symbols are individually engraved or embossed on a series of flat rectangular tiles which are slidably inserted in the desired sequence into the channels of the mounting frame. After insertion into the mounting frame, the encoded plate or tiles are usually held in position by crimping the channels at either end. The assembled tag can than be attached to the utility pole by nails or screws through holes at either end of the mounting frame.

The standard utility pole tag configuration described above is quite limited as to the amount of information it can contain. Such tags are typically less than a foot in length, and their alphanumeric symbols must be large enough to be readable at a distance of a few feet and under low light conditions. Therefore, it is not typical to have more than ten alphanumeric symbols on one tag. By utilizing bar codes, the quantity of information storable on a tag can be greatly increased. Bar codes also increase the reliability and accuracy of data collection.

While there are existing products on the market that provide bar code labels for utility poles, such products lack the versatility of the standard tag configuration with respect to modifying the encoded data. Existing bar code tags for utility poles must be entirely replaced in order to change their information content. On the other hand, the present invention utilizes a bar code insert which may be is slidably inserted into the channels in the mounting frame of the standard tag configuration. Consequently, when the data content of the tag needs to be changed as to the alphanumeric symbols or the barcode, or both—a new bar code and/or new alphanumeric plates/tiles is/are slipped into the existing mounting frame.

The replaceable bar code insert of the present invention can also be utilized in connection with a one-piece tag consisting of a flat oblong metallic or plastic plate affixed directly to the utility pole. In this application, the bar code insert is attached to the obverse face of the tag by a staple, rivet or other fastener and can be removed and replaced as needed.

The replaceable bar code insert of the present invention has the further advantage of production economy. Standard utility pole tags are most economically fabricated in sequences with respect to pole identification numbers. The addition of a bar code insert allows this production economy to be retained while customizing the individual pole data for each tag. Thus, the numerical pole identification in the prefabricated tag can be supplemented by bar coded data relating to apparatus maintenance, for example.

With respect to the prior art in this field, there are a number of patents directed to utility pole tags/markers. Examples of such patents are U.S. Pat. No. 4,863,238, issued to Blair M. Brewster on Sep. 5, 1989, and U.S. Pat. No. 6,584,716 B2, issued to David Leroy Paul on Jul. 1, 2003. While these patents disclose improvements on the standard utility pole tag configuration, they lack the additional element of the bar code insert which distinguishes the present invention.

Several utility pole tags/markers that are commercially available contain bar codes as an integral part of the tag/marker. As mentioned earlier, however, these integral bar code designs lack the advantage of the bar code insert with respect to modifying the data on the tag/marker without replacing the tag/marker itself.

A more recent innovation in utility pole identification systems involves the use of radio frequency identification (RFID) tags. Such a system is disclosed in U.S. Pat. No. 6,621,417 B2 issued to Edgar Alan Duncan on Sep. 16, 2003. Such RFID tags would be programmable with data for asset management, maintenance tracking, etc., and so would have a utility somewhat similar to the bar code insert of the current invention. Nonetheless, the present invention has several advantages, including simplicity of design, cost and reliability, which would render it more useful than the RFID tag system in many applications.

### SUMMARY OF THE INVENTION

The present invention constitutes a reliable, economical and versatile system for encoding information on a tag/marker mountable on a utility pole. This system has the advantage of employing the standard utility pole tag configuration while greatly expanding the maximum information content encodable on the tag through the use of a bar code insert. Since the bar code insert is replaceable, this system retains the flexibility of the standard configuration insofar as it allows the encoded information to be readily modified without replacing the entire tag.

A utility pole identification system having features of the present invention comprises a composite tag having a mounting frame designed to hold one or more inserts containing alphanumeric symbols and/or bar-coded data. The mounting frame is a flat oblong sheet of flexible metal, such as aluminum, with its longitudinal edges turned over toward the obverse face to form parallel channels through which the inserts are slidably inserted. In one embodiment, the inserts comprise one or more long rectangular plates engraved or embossed with multiple alphanumeric symbols and/or one or more bar codes. In another embodiment, the inserts comprise one or more rectangular tiles, each engraved or embossed with a single alphanumeric symbol or a single bar code.

Utility pole information is encoded on the composite tag by sliding one or more inserts into the parallel channels of the mounting frame in the desired sequence. Once all of the inserts are in place, the ends of the channels are crimped to hold the inserts in place. The tag is then attached to a utility pole with nails or screws through multiple openings provided at either end of the mounting frame.

If the need arises subsequently to modify the information encoded on the tag, it is detached from the utility pole and the ends of the parallel channels of the mounting frame are pried open to release the inserts. Different inserts are then slided into the mounting frame, or the same inserts are reinserted in a different sequence in order to modify the encoded information on the tag.

Alternately, a utility pole identification system according to the present invention comprises a one-piece tag consisting of a single flat oblong sheet of metal or plastic with alphanumeric symbols embossed or engraved directly therein/thereon. An insert containing one or more bar codes is attached to the obverse face of the one-piece tag by a staple, rivet or other fastener. The tag is then attached to a utility pole with fasteners, such as nails, screws, or bands, through multiple openings provided at either end of the one-piece tag. If the need arises subsequently to modify the bar-coded data on the tag, it is detached from the utility pole, and the insert containing the bar code(s) is removed from the tag and replaced with another insert containing different bar code(s).

These and other features, aspects and advantages of the present invention will become better understood in light of the following description, appended claims, and accompanying drawings.

### BRIEF DESCRIPTION OF THE DRAWINGS

FIG. 1 is a front view of a composite tag version of the utility pole identification system having a single rectangular plate alphanumeric insert and embodying features of the present invention.

FIG. 2 is a front view of a composite tag version of the utility pole identification system having multiple rectangular tile alphanumeric inserts and embodying features of the present invention.

FIG. 3 is a front view of the one-piece tag version of the utility pole identification system embodying features of the present invention.

### DESCRIPTION OF THE INVENTION

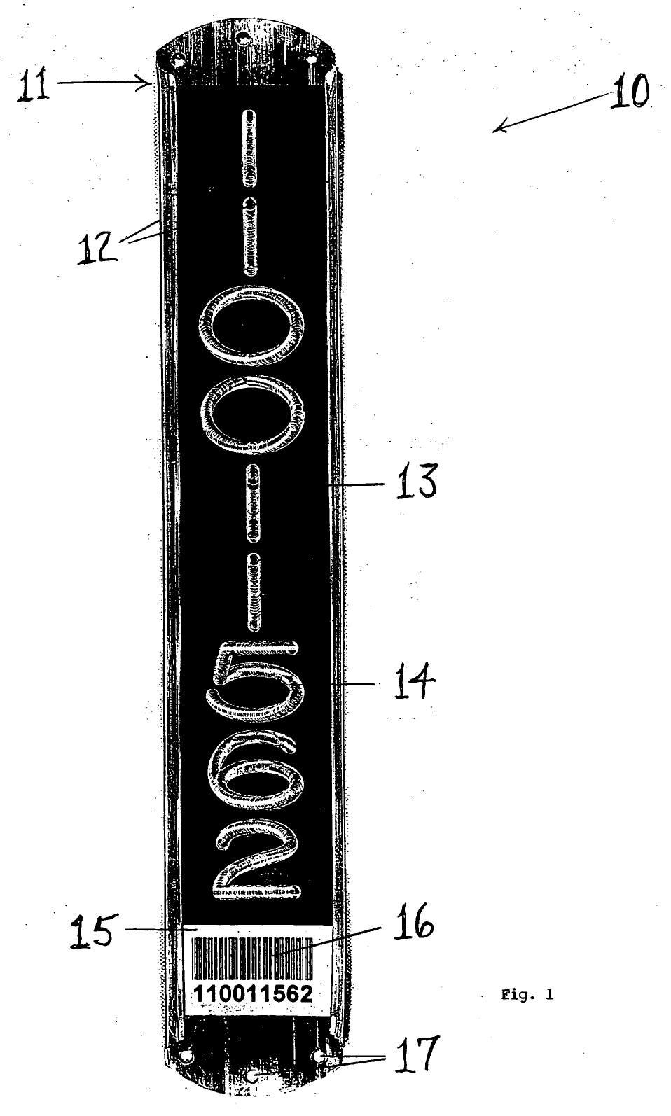

FIG. 1 depicts a composite tag version 10 of a utility pole identification system embodying features of the present invention. The composite tag 10 comprises a mounting frame 11, which is a flat oblong sheet of flexible metal, such as aluminum. The mounting frame 11 has two parallel channels 12, which are formed by turning over the longitudinal edges of the mounting frame 11 toward its obverse face. The composite tag 10 also comprises one or more long rectangular plates 13, fabricated of durable metal or plastic and engraved or embossed with multiple alphanumeric symbols 14 and/or one or more bar codes (not shown). The composite tag 10 further comprises one or more rectangular bar code inserts 15, fabricated of durable metal or plastic and engraved with data in bar code format 16. The long rectangular plate(s) 13 and bar code insert(s) 15 are dimensioned to slide into the parallel channels 12 of the mounting frame 11, and to be held in place when the ends of the channels 12 are crimped.

The alphanumeric symbols 14 and the bar code 16 displayed on the composite tag 10 are used to encode information concerning the utility pole to which the tag 10 is to be affixed. Such information may include pole location, station number, ownership, installation date, and/or the type and rating of the utility apparatus which the pole supports. Information which is subject to frequent change or updating, such as inspection/maintenance dates, is most conveniently stored in the bar code insert 15, which is readily removable from the mounting frame 11 by prying open the crimped lower ends of the parallel channels 12 and sliding it out. The bar code insert 15 is then replaced with a new one containing updated information in bar code format 16, which new insert slides into the lower ends of the parallel channels 12 and is held in place by re-crimping the lower ends of the channels 12.

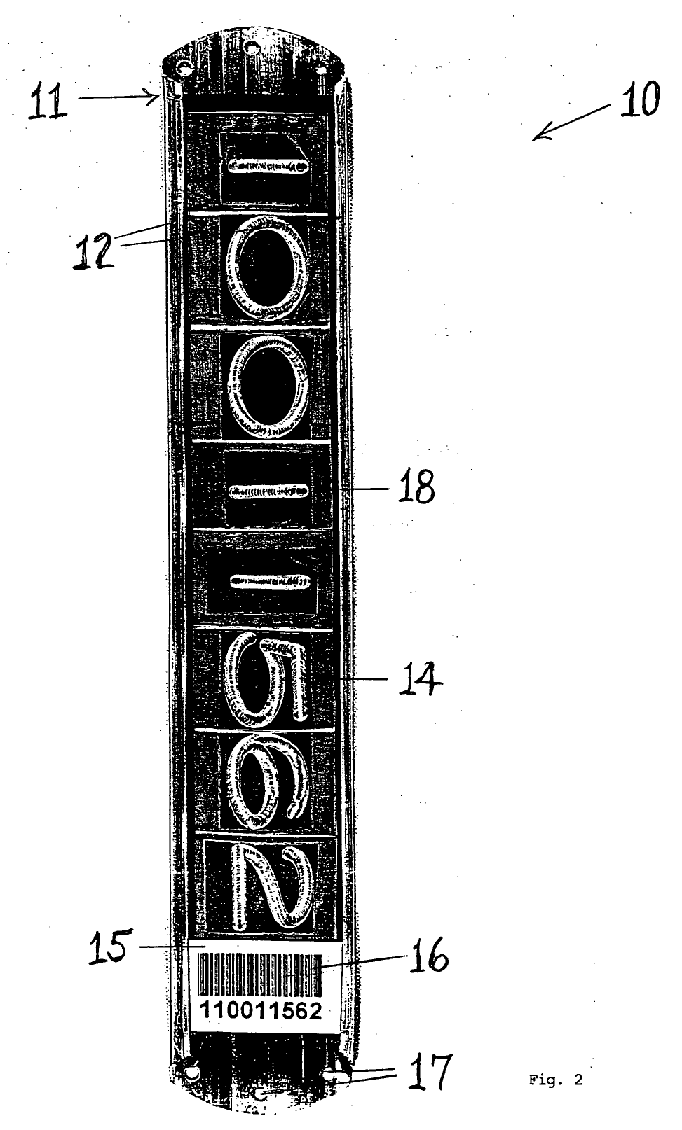

FIG. 2 depicts another composite tag version 10 of a utility pole identification system embodying features of the present invention. In this embodiment, the composite tag 10 again comprises a mounting frame 11, fabricated of flexible metal, with two parallel channels 12 formed by turning over the longitudinal edges of the mounting frame 11 toward its obverse face. In this embodiment, however, the alphanumeric symbols 14 are engraved or embossed on multiple rectangular tiles 18, each of which contains a single alphanumeric symbol 14. The information encoded in the alphanumeric symbols 14 is supplemented in this embodiment by data in bar code format 16 engraved in one or more bar code inserts 15. The rectangular tiles and the bar code insert 15 are dimensioned to slide into the parallel channels 12 of the mounting frame and to be held in place when the ends of the channels 12 are crimped.

The embodiment 10 of the present invention depicted in FIG. 2 facilitates updating of the information encoded in the alphanumeric symbols 14 as well as the bar code 16. In order to perform such updating, the upper ends of the parallel channels 12 are pried open to release one or more of the rectangular tiles 18 and slide them out of the mounting frame 11. The information encoded in the alphanumeric symbols 14 is then modified by altering the sequence of the alphanumeric symbols 14 and/or inserting one or more new rectangular tiles 18 into the mounting frame 11. After the encoded information has been thus modified, the rectangular tiles 18 comprising the altered sequence of alphanumeric symbols 14 are then reinserted into the mounting frame 11 through the upper ends of the parallel channels 12 and the ends are re-crimped.

With respect to the embodiment depicted in FIG. 2, when the need arises to update the information contained in the bar code insert 15, the procedure followed is identical to that described for the embodiment depicted in FIG. 1.

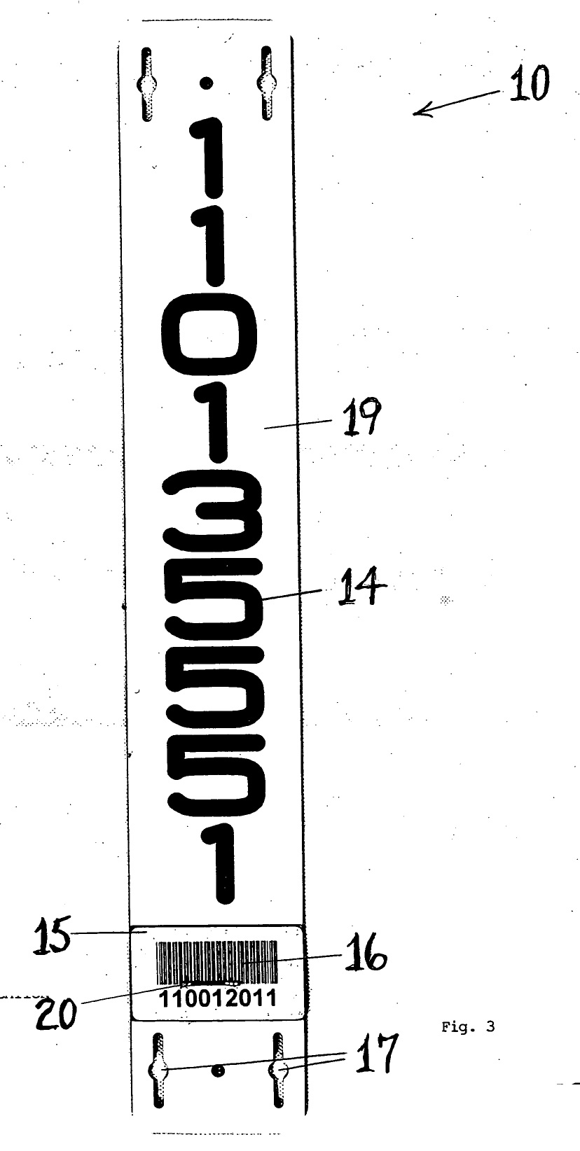

FIG. 3 depicts a one-piece tag version 10 of a utility pole identification system embodying the features of the present invention. This version 10 of the present invention comprises a single oblong sheet 19 of metal or plastic with alphanumeric symbols 14 engraved or embossed directly therein/thereon. This version of the present invention 10 also comprises one or more rectangular bar code inserts 15 which are attached to the obverse face of the oblong sheet 19 by a fastener 20, such as a staple or rivet. Information subject to updating is encoded in bar code format 16 on the bar code insert 15, which is periodically replaced by removing the fastener 20, and affixing a new bar code insert 15 to the oblong sheet 19.

For each of the embodiments depicted in FIGS. 1-3, the tag 10 is attached to a utility pole by means of fasteners, such as nails, screws or bands, inserted through multiple openings 17 provided at either end of the mounting frame 11 (in the case of FIG. 1 and 2) or oblong sheet 19 (in the case of FIG. 3).

The present invention is, therefore, well suited to satisfy the need for a utility pole identification system featuring expanded information storage capacity and the ability to update information conveniently and economically.

While the present invention has been described in some detail with reference to certain currently preferred embodiments, other embodiments are feasible and will readily suggest themselves to those skilled in the art. Therefore, the spirit and scope of the appended claims are not limited to the description of the preferred embodiment contained herein.

1. A composite tag for utility pole identification comprising:
(a) a mounting frame, flat and oblong in shape, having two parallel channels formed by turning over its longitudinal edges toward its obverse face, and having multiple openings at either end to accommodate fasteners, such as nails, screws or bands, by which the mounting frame is attached to a utility pole;
(b) one or more rectangular plates engraved or embossed with multiple alphanumeric symbols and/or one or more bar codes whereby information concerning a utility pole is encoded, which rectangular plates are slidably inserted into the parallel channels of the mounting frame and are held in place by crimping the ends of said channels;
(c) one or more bar code inserts engraved with data in bar code format concerning the utility pole, which bar code inserts are slidably inserted into the parallel channels of the mounting frame and are held in place by crimping the ends of said channels.

2. A composite tag for utility pole identification comprising:
(a) a mounting frame, flat and oblong in shape, having two parallel channels formed by turning over its longitudinal edges toward its obverse face, and having multiple openings at either end to accommodate fasteners, such as nails, screws or bands, by which it the mounting frame is attached to a utility pole;
(b) multiple rectangular tiles, each engraved or embossed with an alphanumeric symbol, the sequence of which encodes information regarding a utility pole, which rectangular tiles are slidably inserted into the parallel channels of the mounting frame and may be are held in place by crimping the ends of said channels;
(c) one or more bar code inserts engraved with data in bar code format concerning the utility pole, which bar code inserts are slidably inserted into the parallel channels of the mounting frame and are held in place by crimping the ends of said channels.

3. A one-piece tag for utility pole identification comprising:
(a) an oblong sheet engraved or embossed with alphanumeric symbols, whereby information concerning a utility pole is encoded, which oblong sheet has multiple openings at either end to accommodate fasteners, such as nails, screws or bands, by which the oblong sheet is attached to a utility pole;
(b) one or more bar code inserts, engraved with data in bar code format concerning the utility pole, which bar code inserts are attached to the obverse face of the oblong sheet by a fastener.
